(19) United States
(12) Patent Application Publication
(10) Pub. No.: US 2022/0083833 A1
(43) Pub. Date: Mar. 17, 2022

(54) OVERLAY SKIMMER PROTECTOR (EOSP)

(71) Applicants: UNIVERSITY OF NORTH TEXAS, Dallas, TX (US); GUARDIAN PAYMENT SOLUTIONS CORP., Georgetown, TX (US)

(72) Inventors: Scott H. BELSHAW, Dallas, TX (US); Len DENTON, Georgetown, TX (US)

(21) Appl. No.: 17/474,414

(22) Filed: Sep. 14, 2021

Related U.S. Application Data
(60) Provisional application No. 63/077,765, filed on Sep. 14, 2020.

(51) Int. Cl. G06K 19/073; G06K 19/07; G06K 19/06; G07F 7/02

(52) U.S. Cl. CPC G06K 19/07309; G07F 7/025; G06K 19/06196; G06K 19/0708

(57) ABSTRACT

A credit card reader comprises a card reader, a keypad, a display, and a protector coupled to a front surface of the credit card reader. The credit card reader can also include a sensor coupled to the protector. The sensor is configured to detect a relative positioning between the protector and the credit card reader.

### CROSS-REFERENCE TO RELATED APPLICATIONS

This application claims the benefit of U.S. Provisional Application No. 63/077,765 filed on Sep. 14, 2020 and entitled, “EAGLE OVERLAY SKIMMER PROTECTOR (EOSP),” which is incorporated herein by reference in its entirety for all purposes.

### STATEMENT REGARDING GOVERNMENTALLY SPONSORED RESEARCH OR DEVELOPMENT

None.

Credit card payment terminals, which can be referred to as simply payment terminals, allow customers to swipe or insert credit cards for payment of goods and services. These payment terminals serve as point of sale devices and are often placed in unmanned locations such as gas station pumps or vending machines. Thieves have been known to placed devices on the payment terminals to obtain the credit card information during a regular transaction. These devices can include skimming devices that are intended to appear as part of the payment terminal and collect information during the credit card payment process. One of the most common forms of credit card skimming, overlays are physical casings placed on top of credit card terminals in self-checkout lanes at gas stations, grocery stores and major retailers. Equipped with Bluetooth technology, these devices allow thieves to swipe data and PINs from up to 300 feet away.

### SUMMARY

These and other features will be more clearly understood from the following detailed description taken in conjunction with the accompanying drawings and claims.

In an aspect, a credit card reader comprises a card reader, a keypad, a display, and a protector coupled to a front surface of the credit card reader.

In some aspects, a credit card reader comprises a card reader, a keypad, a display, a protector coupled to a front surface of the credit card reader, and a sensor coupled to the protector. The sensor is configured to detect a relative positioning between the protector and the credit card reader.

In some aspects, a method of protecting a credit card reader comprises coupling at least one protector to a front surface of a credit card reader, and preventing a placement of a skimmer over the front surface of the credit card reader using the protector. The credit card reader comprises a card reader, a keypad, and a display.

### BRIEF DESCRIPTION OF THE DRAWINGS

For a more complete understanding of the present disclosure, reference is now made to the following brief description, taken in connection with the accompanying drawings and detailed description:

FIG. 1 schematically illustrates an embodiment of a protector.

FIGS. 2A and 2B illustrate another embodiment of a protector.

FIG. 3 illustrates still another embodiment of a protector.

FIG. 4 illustrates another embodiment of a protector on a payment terminal according to some aspects.

FIG. 5 illustrates an embodiment of a protector comprising a sensor.

### DETAILED DESCRIPTION

One of the most common forms of credit card skimming, overlays are physical casings placed on top of credit card terminals in self-checkout lanes at gas stations, grocery stores and major retailers. Equipped with Bluetooth technology, these devices allow thieves to swipe data and PINs from up to 300 feet away. Overlays have been widely used on Ingenico iSC250 credit card terminals across the country. Retailing on the black market for $200 to $300, the overlays can even store card numbers until thieves are ready to upload their cache of stolen data. With a little knowledge, anyone can spot the differences between real card readers and fake ones. Since they must be wider than the target device, overlays will appear larger than the actual point-of-sale (POS) terminal. Other features to look out for include a lack of natural backlighting on the keypad and the absence of a stylus anchored to the side of the device.

As described herein, an anti-skimming device can comprise a protector that can be placed on one or both sides of a credit card terminal to prevent the placement of an overlay skimmer. The protection device can be in a variety of forms including a small device configured to physically interfere with the placement of a skimmer. In some aspects, a sensor or other device can be used to detect any removal or other movement of the protection device, thereby preventing the removal and replacement of the protector on a skimmer.

In general, payment terminals include one or more card reader devices, or equivalents, a display, keypad and/or pinpad or equivalents, and in some aspects, a printer. It will be understood that the present devices and methods are intended to be applicable to all types of terminals and associated systems. While the form factor of the protector may change from device to device, the same protection may be provided by use of the protectors as described herein to help to prevent the placement of a skimmer on a payment terminal. While in some aspects, a specific credit card reader is described and shown herein, any brand of credit card reader that accepts credit cards can benefit from the protector described herein.

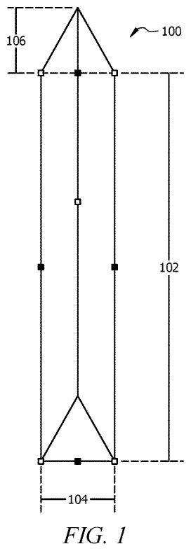

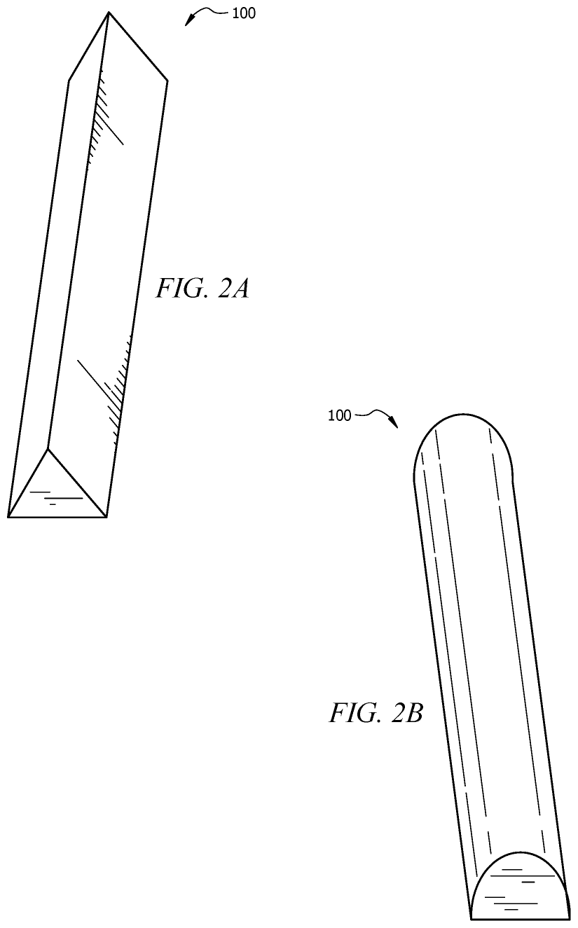

In general, a protector can comprise any device that can be attached to a payment terminal to interfere with the placement of a skimmer on the payment terminal. An exemplary protector 100 is illustrated in FIGS. 1, 2A, and 2B. As illustrated, the protector 100 can have a length 102, a width 104, and a height 106. The length and width may be selected based on the form factor of the payment terminal such that the protector 100 may not interfere with the regular functioning of the payment terminal. For example, the protector 100 may be designed not to interfere with the reading of any credit cards or the use of any keys, pinpads, or screen. The height 106 of the protector 100 may be selected to provide a protrusion from the surface of the payment terminal such that a skimmer may not be able to be placed over the protector 100 without creating a noticeable gap to indicate that a skimmer is present. In some aspects, the height 106 may be selected such that any credit card reader associated with the skimmer may not align with the credit card reader slot or channel of the payment terminal, thereby creating a physical indication of the presence of the skimmer on the payment terminal.

In some aspects, the dimensions of the protector 100 can be selected to extend along the edge of the credit card terminal and have a thickness that is sufficient to prevent the placement of a skimming device. In some embodiments, the protector 100 can have a thickness between about 5 mm and about 25 mm or about 10 mm. As an example of other dimensions, the protector can be between about 30 mm and about 100 mm long, or about 50-60 mm long, depending on the specific credit card terminal used. The protector can have a width and shape selected to fit on the credit card terminal. In some aspects, the protector 100 can have a width between about 5 and 20 mm wide, or about 10 mm wide.

The protector 100 can be formed from any suitable material such as plastic, polymer, metal, composite, or other material. In some embodiments, the protector 100 can comprise a polymeric material. When a sensor is present, the sensor can be disposed within or coupled to the protector 100, and in some aspects, the sensor may be molded into the material of the protector 100.

The protector can have any suitable shape such as a rectangle, circle, triangle, or the like and can have any suitable cross-sectional shape such as triangular, rounded, arced, trapezoidal, or other cross-sectional shape. The size and shape of the protector 100 can be selected so that the overlay skimmer will not fit on the terminal or interfere with the placement of skimmer, thus allowing the criminal to move on to an easier target. The protector can be made to have a variety of easily noticeable colors such as being green, blue, or red for easy detection.

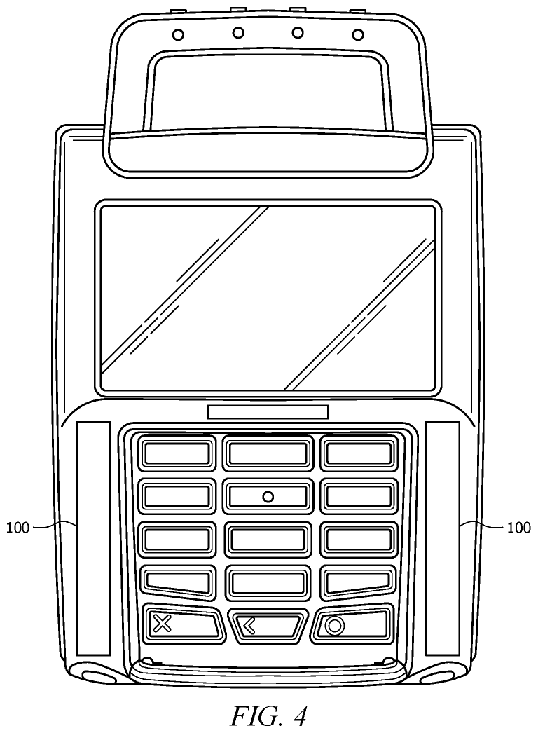

In some aspects, the protector can have a stepped or shaped design. FIG. 4 illustrates an exemplary side view of a protector 300. As illustrates, the protector 300 can have a flat base 302 for coupling to the payment terminal. A shoulder 304 can be formed by having a reduced cross section such that an extension 306 comprising a portion of the protector 300 extends away from the payment terminal surface above the base. This can allow for a desired surface area for bonding to the payment terminal while allowing the extension 306 to prevent the placement of a skimmer on the payment terminal.

The protector can be attached to the credit card terminal using an appropriate coupling mechanism that cannot be easily removed. For example, the protector can be coupled to the credit card reader with a strong adhesive. In some aspects, a physical attachment such as a screw, bolt, or the like may be used in place of or in addition to another method such as an adhesive, tape, or the like. This may keep the criminals from being able to fit any skimmer over the machine.

FIG. 4 illustrates the placement of the protector 100 on a payment terminal 400 credit card reader. As shown, a plurality of protectors 100 can be placed on the credit card reader, so as on each side of the credit card reader. In some aspects, three protectors 100 can be placed on the credit card reader to prevent a skimmer from being placed over the face of the credit card reader. While three are shown in FIG. 4, addition protectors can be placed on the credit card reader, such as around the screen.

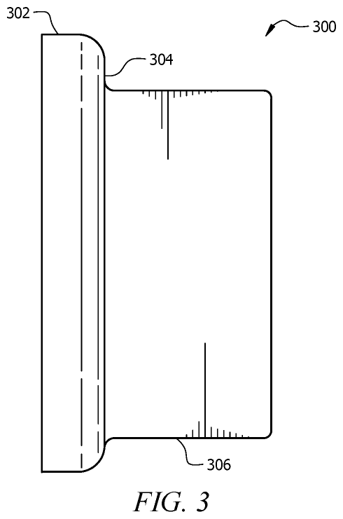

In some embodiments, the protector can be formed from a single piece that can fit around the keypad and/or screen such that a single piece protector can extend across the face of the credit card reader. For example, a single protector (e.g., such as the protector 300 of FIG. 3) can be placed on the payment terminal at or near the credit card reader to prevent the placement of a skimmer on the credit card reader.

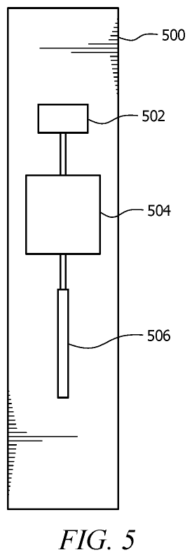

In some embodiments, a sensor can be embedded within the protector to detect any tampering or removal of the protector. FIG. 5 illustrates a schematic example of a protector 500 comprising a sensor 502. The protector 500 can include any of those described herein and can include any form factor. In some aspects, the sensor 502 can comprise any sensor capable of measuring, and configured to measure, any movement or repositioning of the protector 500. In some aspects, the sensor can be configured to measurement any relative movement between the payment terminal and the protector 500 once the protector 500 is installed or coupled to the payment terminal. In some aspects, the sensor 502 can be a pressure sensor, position sensor, contact sensor, or the like. The sensor can be used to detect if the protector is tampered with, such as any effort to remove the protector from the credit card reader.

A processing circuit 504 can be in signal communication with the sensor 502. The processing circuit 504 can comprise one or more processors, memory, applications, or the like. In some aspects, the processing circuit 504 can be an application specific integrated circuit (ASIC). The processing circuit can be configured to receive an output of the sensor 502 and provide the indication of any tampering with the protector 500. A power source may or may not be used with the processing circuit 504 to provide a powered or unpowered output. For example, a battery may be used to power the processing circuit 504.

An output and/or communication device 506 can be in signal communication with the processing circuit 504 to provide an output and/or communications with an external device or network. For example, the output device 506 can comprise an audible output device such as a speaker or alarm can be used to produce a sound if the sensor detects any attempt to tamper or remove the protector, thereby alerting those around the credit card reader of the potential use of a skimmer. In some aspects, the sensor can be coupled to a network through the output device 500 to send an alert along with identifying information for the credit card reader to identify any potential tampering with the credit card reader. In some aspects, the processing circuit 504 may store a state received from the sensor and respond through the output device 506 when queried. For example, a radio frequency identification device (RFID) can be used that can store a state of the sensor (e.g., installed, tampering detected, etc.) and communicate the state through the output device (e.g., an antenna, etc.) when queried by an appropriate device. This can then allow for the detection of a skimmer or tampering with the protector 500 by any suitable measurement device.

In some aspects, a method of protecting a payment terminal can include coupling a protector to a payment terminal. The protector can include any of those described herein. In some aspects, the protector can be coupled to the payment terminal using an adhesive, bonding agent, coupling mechanism (e.g., a screw, bolt, latch, etc.), or the like. Once coupled to the payment terminal, the protector can create an interference with the form factor of any skimmer placed on the payment terminal. For example, the protector can prevent the physical placement of a skimmer on the payment terminal. Any attempt to place and use a skimmer on the payment terminal can then be prevent. In the event that a skimmer is placed on the payment terminal, the protector can provide a visual indication that the skimmer has been placed on the payment terminal by creating a visual gap or indication by causing a misalignment of the skimmer with the payment terminal.

In some aspects, the protector can comprise a sensor. The method can then also include detecting any movement or relative repositioning of the protector with respect to the payment terminal using the sensor. A processing circuit can receive an output from the sensor and provide a signal to indicate that the protector can moved or repositioned with respect to the payment terminal. The output from the sensor can then be used to provide an indication that a skimmer may have been placed on the payment terminal. Various forms of outputs such as a noise, a light, or an output signal sent to a network can be used to provide the indication from the sensor.

Having described various systems and methods, various aspect can include:

In a first aspect, a credit card reader comprises a card reader, a keypad, a display, and a protector coupled to a front surface of the credit card reader.

A second aspect can include the credit card reader of the first aspect, wherein the protector is configured to prevent placement of a skimmer over the card reader.

A third aspect can include the credit card reader of the first or second aspect, wherein the protector has a thickness of between about 5 mm and about 25, or about 10 mm.

A fourth aspect can include the credit card reader of any one of the first to third aspects, wherein the protector is formed from plastic.

A fifth aspect can include the credit card reader of any one of the first to fourth aspects, wherein the protector has a length between about 30 mm and about 100 mm long, or about 50-60 mm long.

A sixth aspect can include the credit card reader of any one of the first to fifth aspects, wherein the protector has a width between about 5 mm and 20 mm wide, or about 10 mm.

A seventh aspect can include the credit card reader of any one of the first to sixth aspects, wherein the protector has a cross section shape selected from the group consisting of: triangular, rounded, arced, and trapezoidal.

An eighth aspect can include the credit card reader of any one of the first to seventh aspects, wherein the protector is coupled to the front surface of the credit card reader with an adhesive.

A ninth aspect can include the credit card reader of any one of the first to eighth aspects, wherein a plurality of protectors are coupled to the front surface of the credit card reader.

A tenth aspect can include the credit card reader of any one of the first to ninth aspects, wherein the protector comprises a sensor configured to detect tampering or removal of the protector from the front surface of the credit card reader.

In an eleventh aspect, a method of protecting a credit card reader comprises coupling at least one protector to a front surface of a credit card reader, wherein the credit card reader comprises: a card reader, a keypad, and a display, and preventing a placement of a skimmer over the front surface of the credit card reader using the protector.

A twelfth aspect can include the method of the eleventh aspect, wherein the protector is configured to prevent placement of a skimmer over the card reader.

A thirteenth aspect can include the method of the eleventh or twelfth aspect, wherein the protector has a thickness of between about 5 mm and about 25, or about 10 mm.

A fourteenth aspect can include the method of any one of the eleventh to thirteenth aspects, wherein the protector is formed from plastic.

A fifteenth aspect can include the method of any one of the eleventh to fourteenth aspects, wherein the protector has a length between about 30 mm and about 100 mm long, or about 50-60 mm long.

A sixteenth aspect can include the method of any one of the eleventh to fifteenth aspects, wherein the protector has a width between about 5 mm and 20 mm wide, or about 10 mm.

A seventeenth aspect can include the method of any one of the eleventh to sixteenth aspects, wherein the protector has a cross section shape selected from the group consisting of: triangular, rounded, arced, and trapezoidal.

An eighteenth aspect can include the method of any one of the eleventh to seventeenth aspects, wherein the protector is coupled to the front surface of the credit card reader with an adhesive.

A nineteenth aspect can include the method of any one of the eleventh to eighteenth aspects, wherein a plurality of protectors are coupled to the front surface of the credit card reader.

A twentieth aspect can include the method of any one of the eleventh to nineteenth aspects, wherein the protector comprises a sensor configured to detect tampering or removal of the protector from the front surface of the credit card reader.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

We claim:

1. A credit card reader comprising:
a card reader;
a keypad;
a display; and
a protector coupled to a front surface of the credit card reader.

2. The credit card reader of claim 1, wherein the protector is configured to prevent placement of a skimmer over the card reader.

3. The credit card reader of claim 1, wherein the protector has a thickness of between about 5 mm and about 25.

4. The credit card reader of claim 1, wherein the protector is formed from plastic.

5. The credit card reader of claim 1, wherein the protector has a length between about 30 mm and about 100 mm long.

6. The credit card reader of claim 1, wherein the protector has a width between about 5 mm and 20 mm wide.

7. The credit card reader of claim 1, wherein the protector has a cross section shape selected from the group consisting of: triangular, rounded, arced, and trapezoidal.

8. The credit card reader of claim 1, wherein the protector is coupled to the front surface of the credit card reader with an adhesive.

9. A credit card reader comprising:
a card reader;
a keypad;
a display;
a protector coupled to a front surface of the credit card reader; and
a sensor coupled to the protector, wherein the sensor is configured to detect a relative positioning between the protector and the credit card reader.

10. The credit card reader of claim 9, wherein the sensor is configured to detect tampering or removal of the protector from the front surface of the credit card reader.

11. The credit card reader of claim 9, wherein the sensor comprises a pressure sensor, position sensor, or a contact sensor.

12. The credit card reader of claim 9, further comprising a processing circuit and an output device in signal communication with the sensor, wherein the processing circuit and the output device are configured to send a signal indicative of the relative positioning between the protector and the credit card reader to an external device.

13. A method of protecting a credit card reader, the method comprising:
coupling at least one protector to a front surface of a credit card reader, wherein the credit card reader comprises: a card reader, a keypad, and a display; and
preventing a placement of a skimmer over the front surface of the credit card reader using the protector.

14. The method of claim 13, wherein the protector is configured to prevent placement of a skimmer over the card reader.

15. The method of claim 13, wherein the protector has a thickness of between about 5 mm and about 25, or about 10 mm.

16. The method of claim 13, wherein the protector is formed from plastic.

17. The method of claim 13, wherein the protector has a length between about 30 mm and about 100 mm long, or a width between about 5 mm and 20 mm wide.

18. The method of claim 13, wherein the protector has a cross section shape selected from the group consisting of: triangular, rounded, arced, and trapezoidal.

19. The method of claim 13, wherein the protector is coupled to the front surface of the credit card reader with an adhesive.

20. The method of claim 13, wherein the protector comprises a sensor configured to detect tampering or removal of the protector from the front surface of the credit card reader.
